(19) United States
(12) Patent Application Publication
(10) Pub. No.: US 2016/0364769 A1
(43) Pub. Date: Dec. 15, 2016

(54) MARKETING DISPLAY CUSTOMIZATION SYSTEM AND PROCESS

(71) Applicant: ELATERAL, INC., Westchester, IL (US)

(72) Inventors: Alexandre Perry Kamel, Castle Pines, CO (US); Peter Blackburn, Franham (GB); Paul Goater, Farnham (GB); Irene Albert, Cincinnati, OH (US); Nathan Libby, Cincinnati, OH (US)

(21) Appl. No.: 15/121,661

(22) PCT Filed: Mar. 10, 2015
(86) PCT No.: PCT/US15/19617

§ 371 Date: Aug. 25, 2016

Related U.S. Application Data
(60) Provisional application No. 61/967,090, filed on Mar. 10, 2014.

(51) Int. Cl. G06Q 30/02; G06F 17/24; G06Q 10/08; G06Q 30/06

(52) U.S. Cl. CPC G06Q 30/0276; G06Q 30/0641; G06F 17/248; G06Q 10/087

(57) ABSTRACT

A marketing display customization system and process are described. The marketing display customization system can include a server, a plurality of databases, a network, and a user device. The marketing display customization system can be implemented to provide a database of chassis templates having one or more rules and/or constraints. The system can be implemented to create a bill of material for a marketing display by selecting one or more display items from a display item database and selecting content for one or more design elements from a design element database. The marketing display customization process can include, but is not limited to, selecting a chassis template, selecting one or more display items for the chassis template, and defining one or more design elements of the chassis template to create a marketing display.

### CROSS-REFERENCE TO RELATED APPLICATION

This application claims the benefit of U.S. Provisional Application No. 61/967,090, filed Mar. 10, 2014.

### BACKGROUND

Historically, 3-dimensional display units have been designed through manual or computer-aided art-working and/or static versioning. The color, images, copy, and other design characteristics were designed by a designer. Typically, any adaptations or customizations to such designs were addressed via manual or semi-manual processing. Similarly, products contained in the 3-dimensional displays were specified and assembled via manual or semi-manual means.

Further, the process of designing and specifying design elements for a 3-dimensional display unit via conventional methods takes considerable time and effort for each display unit. The resulting display units are typically static and difficult to adapt or further customize. Given the need to adapt display units to suit local conditions across highly diverse contexts, the inability to quickly, easily, and cost-effectively customize and adapt display units is a significant limitation of the current state of the art.

Therefore, a system and process for implementing intelligent templates with integrated logic to allow for fast, flexible, and controlled automated specification of display items and related design elements of 3-dimensional display units is needed.

### BRIEF DESCRIPTION OF THE DRAWINGS

FIG. 1 is a flow chart of a marketing display customization process according to one embodiment of the present invention.

FIG. 2A is a graphical representation of a chassis template according to one embodiment of the present invention.

FIG. 2B is a graphical representation of a plurality of surfaces of a chassis template according to one embodiment of the present invention.

FIG. 3 is a flow chart of an example process for creating a chassis template according to one embodiment of the present invention.

FIG. 4 is a flow chart of an example process for selecting display items according to one embodiment of the present invention.

FIG. 5 is a flow chart of an example process for defining design elements according to one embodiment of the present invention.

FIG. 6 is a block diagram of a marketing display customization system according to one embodiment of the present invention.

FIG. 7 is a flow chart of a product packaging customization process according to one embodiment of the present invention.

### DETAILED DESCRIPTION

Embodiments of the present invention include a process and a system of implementing intelligent chassis templates having integrated logic for designing three-dimensional (3-D) marketing displays. The process can be implemented to customize units of product or other tangible items that are put on or into a chassis and customize artwork, images, copy, color, text and other design characteristics of the chassis. Typically, the display items to be displayed by the chassis can be selected first. After the display items have been selected, the design elements can be defined. Defining the design elements can include selecting content for each design element on every surface of the chassis. It is to be appreciated that these two general processes may be used alone or together.

Embodiments of the present invention can be implemented in fields of marketing, advertising, and communications. For instance, embodiments can be implemented in fields where three-dimensional displays can be used for promotional and/or communication purposes. Embodiments can be implemented to design marketing displays for retail marketing and sales, shopper marketing, point-of-sale marketing, point-of-purchase marketing, event marketing, and/or other on-premises marketing and communications purposes.

Marketing displays include, but are not limited to, retail displays, in-store displays, point-of-sale displays, floor displays, end-cap displays, et cetera. The term marketing display can refer to in-store materials that show, hold, feature and/or otherwise display one or more products. For instance, marketing displays can include, but are not limited to, pallets, shelves, and shelf-ready packs. Typically, displays can be located anywhere in a store including, but not limited to, aisles, on shelves, at an end of a shelf, and free standing on a floor.

Embodiments of the present invention can facilitate an establishment and an enforcement of design standards, compliance requirements, and other rules intended to govern relationships between and amongst the chassis, the design elements, the display items, and the display spaces. In one embodiment, the chassis, the display items, the design elements, and the display spaces can include parameters and rules that can be translated into or embodied within the chassis templates. For instance, logical rules can be implemented to control selection of display items and customization of design elements for a particular chassis template. Typically, the parameters, the rules, and the constraints can be defined and stored in metadata of the chassis template.

Generally, the chassis templates can each follow a defined set of rules or logic. For instance, the chassis templates can include logical coding that can specify rules governing selection and presentation of various display items and design elements. Display items can typically include products to be displayed by the chassis. For instance, the display item may be a bottle of shampoo or a container of toothpaste. Design elements can include, but are not limited to, images, text boxes, background color, logos, artwork, photographic elements, and other objects appearing on the chassis. The display spaces can be areas of the chassis designated to present the display items.

In one embodiment, logical coding can be implemented to specify rules for interaction between display items, design elements, display spaces, between display items and design elements, and between display items and display spaces. For instance, logical coding can be implemented to enforce desired consistency in the chassis and/or to enforce logical relationships governing selection and presentation of display items appearing on different display spaces of the chassis. Generally, logical rules can include, but are not limited to, if-then-else statements, inclusion, exclusion, and other relational or logical rules.

Rules governing relationships between and among the display items and design elements can be established for each chassis template. For instance, photographic images, artwork, product features, pricing information, and other characteristics of design elements included in the chassis template can be governed by various logical relationships, business rules, artistic standards, creative standards, branding standards, and other rules to achieve an objective with regard to the display items that can be produced by virtue of intelligence and/or logic associated with the chassis template.

Generally, a subset of rules can be implemented to establish consistency among the surfaces of the chassis template. For instance, subsets of rules can be implemented for logical constraints, dependencies, and other relationships. For example, if a certain design element appears on more than one surface of the chassis template, the design element should appear similar on any other surface on the chassis template. In another example, rules may be implemented so that a disclaimer (or similar compliance language) be consistently applied where needed across the chassis template.

It is to be appreciated that alternative rules are contemplated that can control degrees of freedom and constrain customization options based on a variety of factors. For instance, these factors can include, but are not limited to, design objectives, marketing objectives, communications objectives, and policies related to individual users. It is to be appreciated that individual users can have different access and editorial rights.

In one embodiment, the present invention may include a program or application for defining, managing, and associating rules with various display items and design elements associated with various chassis. In one embodiment, the program may be adapted to enable automated generation of an overall chassis design including particular design elements based on a selection of one or more display items. For instance, the program may be adapted to automatically generate design elements based on a selection of display items or a single display item.

In one embodiment, the program can include manager level functions including, but not limited to, reviewing and approving of chassis customizations. For instance, one or more approval authorities may be given manager level access to review and approve chassis customizations.

In one embodiment, the program can be implemented to execute an order and fulfillment of a completed chassis design. For instance, the program can generate a bill of material. Typically, the program can be configured to create a customized chassis template file. It is to be appreciated that the customized chassis template file can be one of a plurality of file formats known to one of ordinary skill in the art. The customized chassis template file can include information related to the chassis template, each display item selected, each design element defined, content selected for the design elements, and other pertinent information for fabricating a marketing display. In one embodiment, a marketing display can be fabricated from the customized chassis template file.

In one embodiment, the program can include an application for a designer to create a chassis template. Many times, the designer can create a chassis template based on space available at a store, size of items to be displayed, nature of the display items and the relation of the display items to each other. The designer may further specify which display items or collections of display items may be available for the chassis template. Further, the designer may create a reference display design creating a look, feel, layout, images, copy, color text, for the chassis template. The chassis template can then typically be stored in a chassis template database.

Embodiments of the present invention can provide several benefits. First, the present invention can provide freedom and flexibility for users to customize display items and design elements while enforcing an overall design concept including specifications, business rules, compliance requirements, and other desired constraints. Second, the automation of the customization process can significantly reduce time and cost required to customize and provision a marketing display. Third, by reducing the time and cost required to customize and provision marketing displays, embodiments of the present invention allow a significant increase in an amount of customization that can be supported across a distributed marketing and communications environment. Fourth, the increased customization can enable significantly more relevance and localization in the use of a marketing display. Finally, users are able to increase agility and frequency with which the marketing displays are updated, adapted, and/or optimized.

In one embodiment, product packaging templates can be implemented in place of the chassis templates. The product packaging templates can typically be stored in a product packaging template database. Product packaging can include, but is not limited to, three-dimensional packaging for small quantities of product presented for sale. Typically, the product packaging templates can be implemented in the system and process described herein.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise professed in a suitable manner, if necessary, and then stored in a computer memory.

The following PCT applications are incorporated by reference in their entirety: PCT/US14/32996, filed Apr. 4, 2014, titled “MULTI-CHANNEL QUEUING”; PCT/US14/31403, filed Mar. 21, 2014, titled “MULTI-TEMPLATE KIT SYSTEM AND PROCESS”; PCT/US14/20694, filed Mar. 5, 2014, titled “TEMPLATE METADATA”; and PCT/US13/62971, filed Oct. 2, 2013, titled “CONTENT ANALYTICS”.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “content analytics” or “asset analytics,” as used in this specification and the appended claims, refer to an assessment and characterization of an asset's demonstrated capacity to contribute to an effectiveness of a communications initiative under a variety of communications contexts with regard to an achievement of a variety of desired outcomes, whether for discrete initiatives, types of initiatives, or cumulative impact across all initiatives where the asset has participated over a span of time.

The term “communications campaign,” as used in this specification and the appended claims, refers to a marketing campaign, an advertising campaign, a public service announcement, etc. The communications campaign can include one or more communications.

The term “communication,” as used in the specification and the appended claims, refers to any type of media adapted to present information.

### An Embodiment of a Marketing Display Customization Process

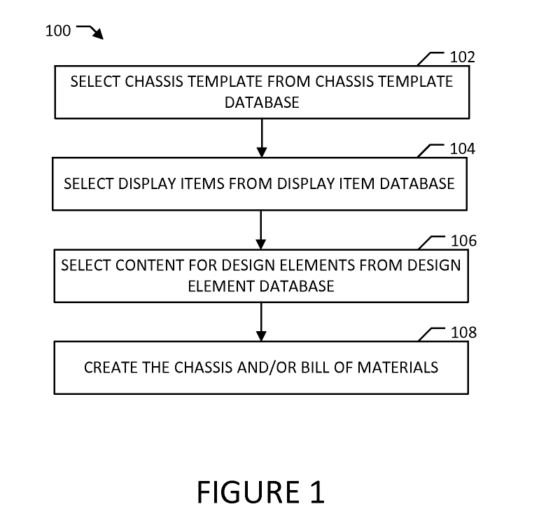

Referring to FIG. 1, a flow chart of a method or process 100 is illustrated. The process 100 can be implemented to customize a chassis template, including products, for creating a 3-dimensional marketing display. Marketing displays can include, but are not limited to, retail displays, in-store displays, point-of-sale displays, floor displays, end-cap displays, et cetera.

In block 102, a chassis template can be selected from a database including a plurality of chassis templates. Each of the chassis templates included in the database can generally include one or more design elements regulated by one or more pre-defined rules. Generally, the chassis template database can include a plurality of parameters defining each of the chassis templates. For instance, the parameters can include, but are not limited to, chassis dimensions, chassis type, number of shelves, maximum number of design elements, minimum number of design elements, display item restrictions, chassis weight, chassis weight limitations, etc.

In one embodiment, each of the chassis templates can include metadata. The metadata can be implemented to store relevant information about the chassis template. For instance, the metadata can store information related to dimensions of the chassis, display space dimensions, a number of design elements, etc. Typically, the metadata can be updated with new data as a chassis is being designed from the chassis template

It is to be appreciated that metadata can be provided in normalized relational tables, XML tables, flat-file tables, and/or other suitable metadata tables. It is to be appreciated that many different characteristics and/or chassis template parameters can be envisioned and included as part of the chassis template metadata depending on specific circumstances and intended applications for a given use.

After the chassis template has been selected, the process 100 can move to block 104. In block 104, one or more display items can be selected to be displayed by the chassis. Typically, the chassis template can include size parameters defining one or more display spaces to determine which display items are available to be displayed by the chassis. For instance, a chassis template may include restrictions on a size of display items to be displayed. For example, the chassis template may include a first display space having a height of 8 inches and a 20 inch depth. Display items that are taller than 8 inches would not be available to be displayed by the first display space of the chassis.

In one embodiment, customizing a selection of display items can include rules governing availability and a selection of various display items to be defined and automatically managed. It is to be appreciated that a plurality of rules can be incorporated into the logic adapted to govern the selection of display items associated with a chassis. These rules can include, but are not limited to, location rules, inter-relationship rules, quantity rules, accessibility rules, venue rules, etc.

Location rules can include rules governing which type of display items may be selected for certain display spaces of a chassis. For example, certain display spaces can include a top shelf, a middle shelf, or a bottom shelf of a box display. Inter-relationship rules can include rules governing a relationship between display items selected for display. For example, if a first display item is selected for the top shelf, then the first display item cannot appear on any other shelf. In another example, a rule may dictate that the first display item must be accompanied by a second display item, or if a third display item is selected, then a fourth display item must appear next to the third display item on the chassis. Quantity rules can include rules governing a number of display items available to be included in any particular location or position of the chassis. For instance, display items can be available based on a size of the chassis, a size of display items, and spacing requirements between the display items and between the display items and the chassis. For example, display items may be available based on spacing requirements between the display items and the front, back, or sides of a chassis. Accessibility rules can include rules that specify available display items based on access and editorial rights associated with a particular user. Venue rules can include rules that specify and/or modify parameters and rules governing display item availability based on a particular venue where the chassis is intended to be used.

Typically, metadata of the chassis template can be updated after each display item is selected. The metadata can be updated with information related to the selected display item available from a display item database.

In one embodiment, the steps 102 and 104 can be reversed. For instance, the display items can be selected first and then the chassis template can be selected based on the display items selected. For example, one or more display items can be selected, and then one or more chassis templates can be identified and presented for selection.

In block 106, content for design elements of the chassis template can be selected. Design elements can include, but are not limited to, images, text boxes, background color, logos, artwork, photographic elements, copy, text, layout, other characteristics that may define a look, feel, and messaging associated with a chassis, and other objects appearing on the chassis. Typically, content for the design elements can be selected from a design element database including a plurality content for each type of design element.

In one embodiment, customizations of the design elements can be based on intelligent templates that implement logical rules. The rules can define choices available for customization of the design elements and govern a relationship between and among the design elements and the display items.

Typically, a chassis can have one or more surfaces and each of the surfaces may be independently designed. Rules can be implemented to govern relationships between and among the one or more surfaces. Each surface of the chassis can include one or more design elements. For example, a first surface may include a first design element, a second design element, and a third design element. The design elements may illustrate various types of marketing including images, copy, and text. In some instances, the same design elements may appear on more than one of the surfaces.

In one embodiment, rules can be implemented to govern customization of design elements for each surface of a chassis template. For instance, the rules can be implemented to reflect design specifications, available design choices, and design constraints. Typically, a user may customize the chassis template by selecting content based on implemented rules. These rules can include, but are not limited to, accessibility rules, single surface inter-relationship rules, multi-surface inter-relationship rules, display item and design elements relationship rules, and auto-generated design element rules. In some embodiments, content available for each design element can be defined for each chassis template. For instance, rules may govern a design element differently for different chassis templates.

Accessibility rules can include rules that govern an availability of content based on access, editorial rights, and privileges of a user. Single surface inter-relationship rules can include rules that govern a relationship between and amongst combinations of design elements on a particular surface of a chassis. For example, a selection of content for a first design element may decrease a number of remaining content available for a second design element. Multi-surface inter-relationship rules can include rules that govern relationships between and amongst combinations of design elements appearing on more than one surface of a chassis. For example, if content is chosen for the first design element on a first surface, then the content for the first design element can also appear for the first design element on a second surface, etc. Display item and design element relationship rules can include rules that govern a relationship between and amongst combinations of design elements and display items that have been selected or defined for the chassis template. For example, if a first display item and a second display item are selected, then the content available for a set of design elements may be narrowed based on the selected display items.

Typically, metadata of the chassis template can be updated after content is selected for each design element of the chassis template. For instance, the metadata can be updated with information related to the selected content and design element available from a design element database.

After the design elements are defined, the process 100 can move to block 108. In block 108, a bill of materials can be created for the chassis. In some embodiments, the designed chassis can be created in block 108. In one embodiment, the bill of materials can be created from updated metadata of the chassis template. Typically, the updated metadata can include information related to the selected display items and defined design elements. The bill of materials can include, but is not limited to, a list of materials, sub-assemblies, intermediate assemblies, sub-components, parts, and quantities of each needed component to manufacture the chassis. The bill of materials can further include product SKUs and production order details. The production order details can include shipping information and deployment start dates. In some embodiments, the bill of materials and/or production order can include content files for use in creating the marketing display. For instance, if an image of a company logo is selected for a design element, the bill of materials can include a file of the image.

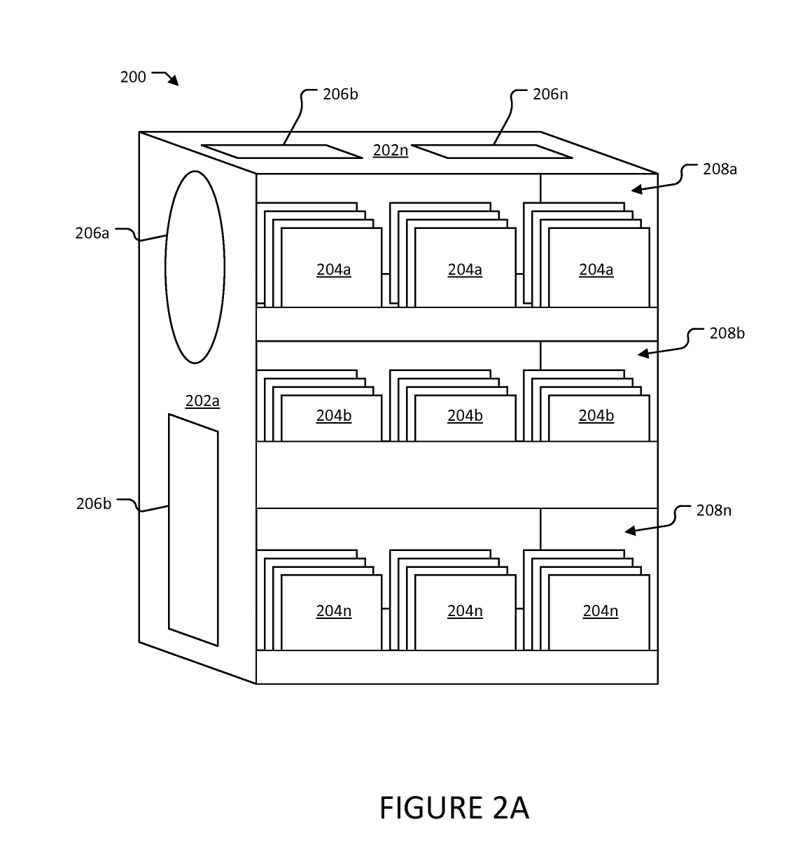

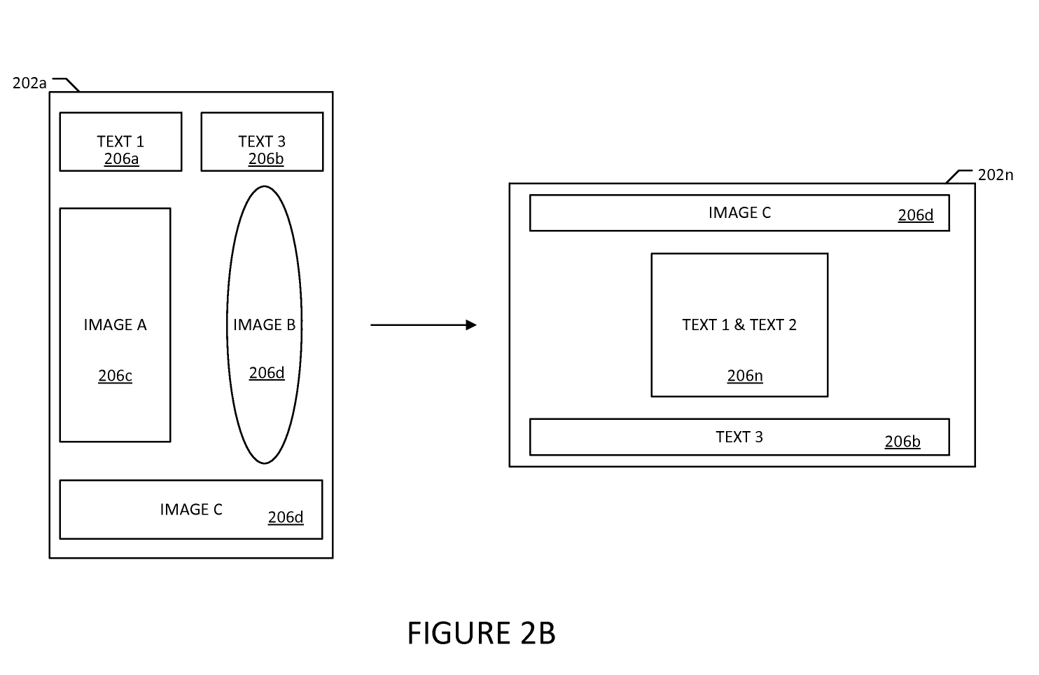

Referring to FIG. 2A, a diagram of an example chassis template 200 is illustrated. As shown, the chassis template 200 can include a plurality of surfaces 202a-202n, a plurality of display items 204a-204n, a plurality of design elements 206a-206n, and a plurality of display spaces 208a-208n. It is to be appreciated that the chassis template 200 is one example of a 3-dimensional marketing display and is provided for illustrative purposes only.

In a typical implementation, after the chassis template 200 has been selected, the display items 204a-204n can be selected. Typically, a first set of display items can be presented that includes items that will fit within one of the display spaces 208a-208n. The chassis template 200 can generally include dimensions for each of the display spaces 208a-208n. The first set of display items can include all display items from the display item database that will fit into one of the display spaces 208a-208n. In some instances, the first set of available display items can be narrowed to focus on a particular type of display item. For example, the first set of available display items can be narrowed to only include products related to shampoo.

Typically, a first display item 204a selected can be a main product for the marketing display. For example, the first display item 204a can be sized to fit in the first display space 208a and may be a shampoo product. The display item database can generally include data for each display item. For instance, display item data can include, but is not limited to, size, type, brand, category, color, shape, quantity, suggested price, and related products.

Once the first display item 204a has been selected, a second set of display items can be presented. The second set of display items can generally include items related to the first display item 204a and be sized to fit into the second display space 208b. It is to be appreciated that other rules and parameters may limit the items included in the second set of display items. In the example presented previously where the first display item 204a is a shampoo product, the second display item 204b may be a conditioner product made by the company who makes the shampoo product.

After a second display item 204b has been selected, a final set of display items can be presented. The final set of display items can generally include items related to the first display item 204a and the second display item 204b. For example, the final set of display items may include hair care products made by the company who makes the shampoo and conditioner already selected. The final set of display items can be sized to fit in the final display space 208n. A final display item 204n can be selected to appear in the final display space 208n. For example, a styling product may be selected that is made by the company who makes the shampoo and the conditioner already selected.

Next, after each of the display items are selected, the design elements 206a-206n can be defined. Typically, the design elements can be related to the display items previously selected. Based on the previously presented example, content for the design elements 206a-206n can generally relate to shampoo, conditioner, or hair care products.

Referring to FIG. 2B, a diagram of the first surface 202a and the final surface 202n are illustrated. It is to be appreciated that the chassis template 200 includes a plurality of surfaces and the first surface 202a and the final surface 202n are shown for illustrative purposes only.

Each of the surfaces 202a-202n can include one or more design elements 206a-206n. Typically, the chassis template 200 can include a predetermined number of design elements and a general type of design element for each included design element. For instance, a first design element 206a can be a text element, a second design element 206b can be a text element, a design element 206c can be an image element, and a design element 206n can be a text element.

In one embodiment, the design elements 206a-206n can be linked together. For instance, the design elements 206a-206n can be interconnected whereby when a design element is updated, changed, and/or defined for one surface of the chassis template, and the defined design element is included on at least two surfaces of the chassis template, the change will be made to the design element on the surfaces having the design element. For instance, if content is selected for the text design element 206b on the first surface 202a, each surface having the text design element 206b will be updated with the selected content of the text design element 206b.

In some embodiments, each of the design elements can have their own rules associated with being a part of the chassis template. For instance, an image design element can have different image resolutions on different surfaces. For example, the image design element 206c on the first surface 202a may have a 1280×720 max resolution and the image design element 206c on the final surface 202n may have a 1920×1080 max resolution. In another example, the first text design element 206a on the first surface 206a may be limited to Times New Roman font, whereas the text design element 206n on the final surface 202n may be limited to Calibri font. As such, when one of the design elements are updated on a surface, the design element will be updated according to any rules on each of the surfaces having the selected design element.

### An Example Process for Creating a Chassis Template

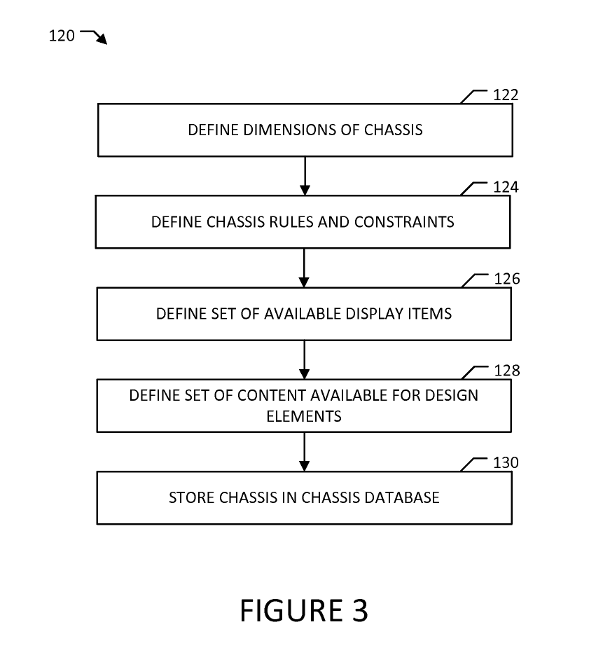

Referring to FIG. 3, a flow chart of an example method or process 120 is illustrated. The process 120 can be implemented to create a chassis template for a chassis template database.

In block 122, dimensions of the chassis can be defined. The chassis dimensions can include, but are not limited to, height, length, width, number of shelves, weight, display space dimensions, etc. Typically, the chassis can include metadata. The metadata can be implemented to store information related to the chassis template. The metadata can typically be saved to storage after each update or change to the metadata. It is to be appreciated that such properties can be specified in terms of either structured or unstructured metadata. It is also to be appreciated that any means for attaching data to metadata can be implemented without exceeding a scope of the present invention.

Once the dimensions of the chassis have been defined, the process can move to block 124. In block 124, one or more rules and constraints can be defined. The chassis rules can include, but are not limited to, types of display items allowed, number of different types of display items allowed, interrelationships between display items, location limitations, types of design elements allowed, number of design elements allowed, interrelationships between design elements, and relationships between design elements and display items. Typically, the one or more rules and constraints can be stored in metadata of the chassis template.

In block 126, a set of available display items can be defined. Typically, the display items can be available based on a size of the display item and a size of display spaces included with the chassis template. In some embodiments, the chassis template can be implemented for a particular type of display item, and the set of available display items may be narrowed to only include display items of the particular type. Information relating to the set of available display items for the chassis template can be stored in metadata of the chassis template.

In block 128, a set of design elements can be defined. In addition to rules determining which content is available for the design elements, the chassis template can include a list of available content for the design elements. For instance, the chassis template can include particular content based on a size of the design elements. In another instance, the chassis template can include particular content based on the available display items. For example, a chassis template adapted to be used with alcohol or tobacco may always include legal disclaimers relating to health issues related to using said alcohol or tobacco. Information relating to available content for the set of design elements for the chassis template can be stored in metadata of the chassis template.

In block 130, the chassis template can be stored in a chassis template database. It is to be appreciated that a variety of information related to descriptive information deemed useful in specifying design requirements of a chassis template can be included in the chassis template metadata.

In some embodiments, a reference display design can be created for each of the chassis templates. The reference display design can include a sample chassis fully designed with display items and corresponding design elements. The reference display design can be implemented to allow a user to quickly determine if a particular chassis template could be implemented by the user.

### An Example Process for Selecting Display Item(s)

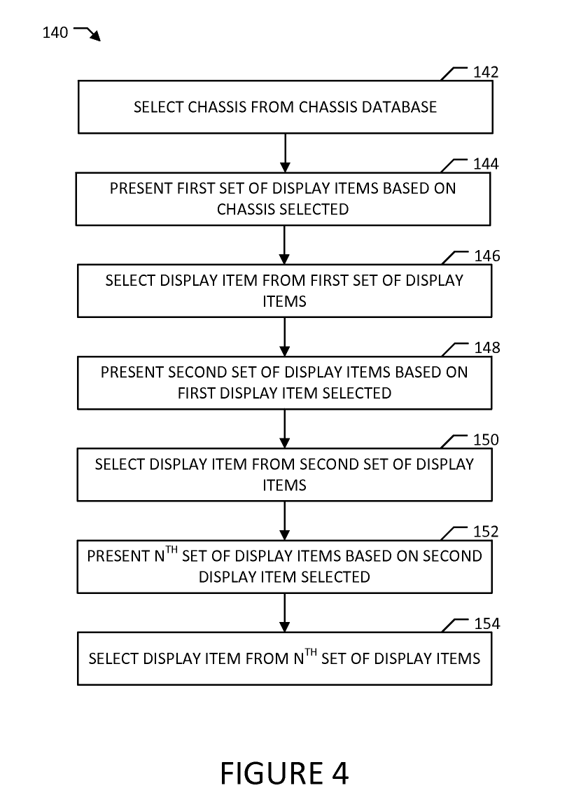

Referring to FIG. 4, a flow chart of an example method or process 140 is illustrated. The process 140 can be implemented to select one or more display items for a chassis template.

In block 142, a chassis template can be selected from a chassis template database. Typically, the chassis template can be selected based on particular needs of a user. For instance, a user may need to select a chassis template that can be placed in an aisle of a grocery store.

After the chassis template has been selected, the process 140 can move to block 144. In block 144, a first set of display items can be presented based on the chassis template selected. Typically, as described beforehand, the chassis template can include one or more rules that can determine which display items are available for the chassis template.

In block 146, a first display item can be selected from the first set of display items. Generally, the first display item can be a main product for the chassis. After the first display item is selected, information about the first display item can be saved to the chassis template metadata.

After the first display item is selected, a second set of display items can be presented in block 148. Generally, the second set of display items can include display items that have a relationship to the first display item. For instance, if the first display item is shampoo, the second set of display items may include conditioner, body soap, and other related products.

In block 150, a second display item can be selected from the second set of display items. After the second display item is selected, information about the second display item can be saved to the chassis template metadata.

In block 152, an n^{th} set of display items can be presented based on the second display item selected.

In block 154, an n^{th} display item can be selected from the n^{th} set of display items. After the n^{th} display item is selected, information about the n^{th} display item can be saved to the chassis template metadata.

### An Example Process for Defining Design Element(s)

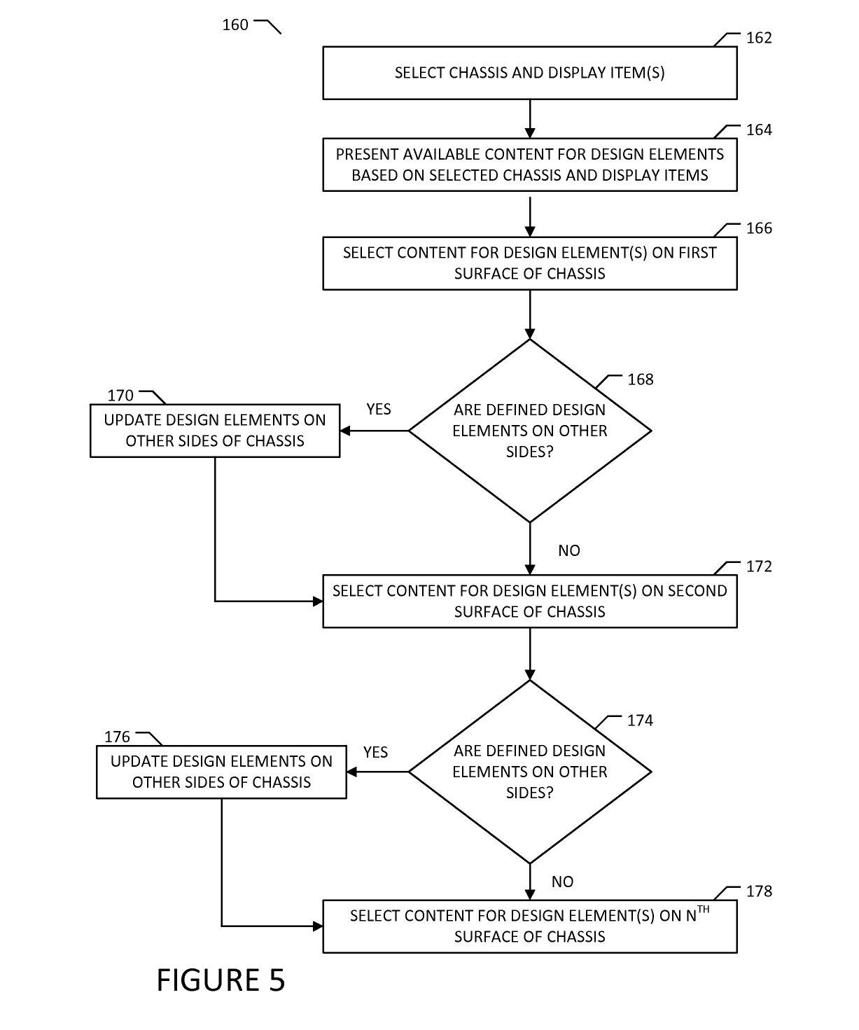

Referring to FIG. 5, a flow chart of an example method or process 160 is illustrated. The process 160 can be implemented to select content for each design element included with a chassis template. Typically, a database of design elements can be implemented that stores a plurality of content for each type of design element.

In block 162, a chassis template and one or more display items can be selected. Typically, the chassis template can include a predetermined number of design elements for each surface of the chassis. The chassis template can include rules for determining relationships between design elements on the same surface and rules determining relationships between design elements on different surfaces. In some embodiments, rules can be implemented based on which display items are selected. For instance, for products needing legal disclaimers, the chassis template can include predetermined locations for design elements presenting legal disclaimers.

In block 164, a set of available content for the design elements can be presented based on the chassis template and the display items selected. Typically, the content for the design elements can be stored in a design element database. The design element database can include information for content stored in the database.

In block 166, content can be selected from the set of available content for the design elements on a first surface of the chassis template. Once the content is selected for design elements on the first surface, the process 160 can move to decision block 168.

In decision block 168, if any of the defined design elements are included on any other surfaces, the process 160 can move to block 170. If the defined design elements are not included on any other surfaces, the process 160 can move to block 172.

In block 170, defined design elements included on other surfaces can be updated with the content selected for the design element on each surface of the chassis template.

In block 172, content can be selected from the set of available content for design elements on a second surface of the chassis template. Once the content has been selected for design elements on the second surface, the process 160 can move to decision block 174.

In decision block 174, if any of the defined design elements are included on any other surfaces, the process 160 can move to block 176. If the defined design elements are not included on any other surfaces, the process 160 can move to block 178.

In block 176, defined design elements that are included on other surfaces can be updated with the content selected for the design element on each surface of the chassis template.

In block 178, content for design elements on an n^{th} surface can be selected from the set of available content.

Typically, after each design element is defined, the chassis template metadata can be updated with information related to the content selected for the design element. In embodiment, the chassis template metadata can be updated after each design element is defined.

In an example implementation of the process 160, a chassis template may include four design elements on a first surface of the chassis. A first design element may be an image, a second design element may be a text box, a third design element may be an image, and a fourth design element may be a text box. A user may select from a list of available content what each of the design elements will be. For instance, the first design element can be an image of a woman brushing her teeth. The user can select content for each of the design elements included on the first surface. If any of the defined design elements are included on other surfaces of the chassis template, the design elements can be updated on each surface. For instance, if a second surface and a fourth surface each includes the first design element, the first design element on the second surface and the fourth surface would be updated to an image of a woman brushing her teeth. After each design element is defined, the chassis template metadata can be updated with information about the selected content.

An Embodiment of a Marketing Display Customization System

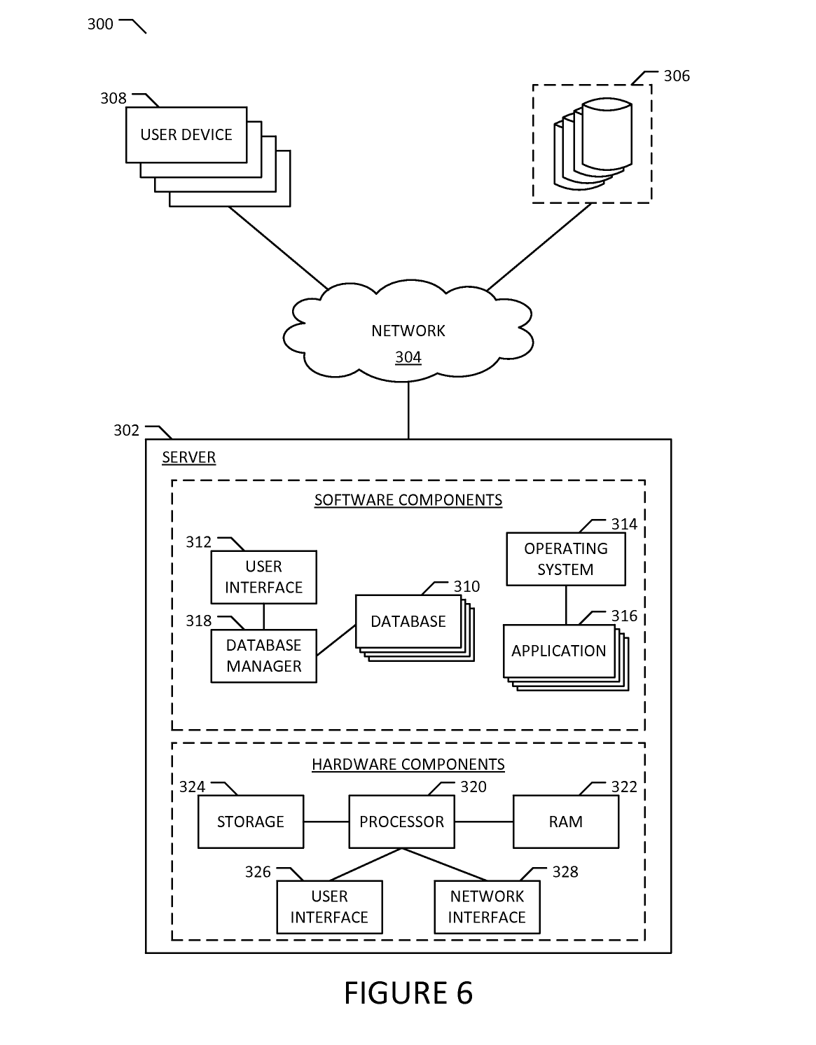

Referring to FIG. 6, a detailed diagram of an embodiment 300 showing a marketing display customization system is illustrated. The marketing display customization system 300 can be implemented to design a 3-dimensional marketing display from a chassis template.

Generally, the customization system 300 can include a server 302, a network 304, one or more databases 306, and one or more user devices 308.

Generally, a repository of chassis templates can be stored in the server 302. For instance, the repository of chassis templates can be stored in one or more databases 310 of the server 302. It is to be appreciated that the repository of chassis templates can be stored externally to the server 302. For instance, the databases 310 can be remotely located from the server 302. Typically, a user can access the database 310 and search, query, filter, and/or prioritize the repository of chassis templates. For instance, the databases 310 can be accessed through a web interface. In another instance, the user can have direct access to the databases 310. For example, the server 302 can include a user interface or web based interface 312 to access the databases 310.

The server 302 can represent a server or another powerful, dedicated computer system that can support multiple user sessions. In some embodiments, the server 302 can be any type of computing device including, but not limited to, a personal computer, a game console, a smartphone, a tablet, a netbook computer, or other computing devices. In one embodiment, the server 302 can be a distributed system wherein server functions are distributed over several computers connected to a network. The server 302 can typically include a hardware platform and software components.

The software components of the server 302 can include the one or more databases 310 which can store a plurality of chassis templates. The software components can also include an operating system 314 on which various applications 316 can execute. A database manager 318 can be an application that runs queries against the databases 310. In one embodiment, the database manager 318 can allow interaction with the databases 310 through an HTML user interface on a user device 308.

The hardware platform of the server 302 can include, but is not limited to, a processor 320, random access memory 322, and nonvolatile storage 324. The processor 320 can be a single microprocessor, multi-core processor, or a group of processors. The random access memory 322 can store executable code as well as data that can be immediately accessible to the processor. The nonvolatile storage 324 can store executable code and data in a persistent state.

The hardware platform can include a user interface 326. The user interface 326 can include keyboards, monitors, pointing devices, and other user interface components. The hardware platform can also include a network interface 328. The network interface 328 can include, but is not limited to, hardwired and wireless interfaces through which the server 302 can communicate with other devices including, but not limited to, the user devices 308.

The network 304 can be any type of network, such as a local area network, wide area network, or the Internet. In some cases, the network 304 can include wired or wireless connections and may transmit and receive information using various protocols.

The plurality of databases 306 can include, but is not limited to, a display item database, a design elements database, a compliance requirements database, a brand guidelines database, a retailer database, a merchandising database, and a campaign plan database. Typically, the plurality of databases 306 can store data and information accessible by the server 302 and the user devices 308. For instance, each of the databases 306 can generally be stored in nonvolatile storage. It is to be appreciated that one or more of the databases 306 can be remote from the other databases 306. In some embodiments, the databases 306 can each be at separate locations. In one embodiment, each of the databases 306 can be at the same location.

The one or more user devices 308 can be any type of computing device on which a browser can operate. Examples of such devices can include, but are not limited to, desktop computers, laptop computers, tablet computers, mobile telephones, game consoles, network appliances, or any other web-enabled devices. In an embodiment, the user devices 308 can have various hardware platforms on which a browser can execute and include nonvolatile storage. The browser can be used to access the HTML user interface of the database manager 318. In one instance, the system can execute functional operations by virtue of service calls to a service-based processing system.

In one embodiment, the marketing display customization system 300 can include a chassis template customization program. Generally, the chassis template customization program can be implemented as an application. It is to be appreciated that the application can be embodied on a variety of computing devices. For instance, the chassis template customization application can be embodied on a user device 308 including, but not limited to, a smart phone, a laptop, a desktop, and a tablet. The chassis template customization program can provide access to the chassis template database 310.

In a typical implementation, a user can run the chassis template customization application on a user device 308 to access the chassis template database 310 and create a marketing display. The chassis template customization application can be implemented to design a marketing display by selecting a chassis template, defining one or more display items to include in the chassis template, selecting design elements for the chassis template, and generating a customized chassis template file. Typically, the chassis template customization application can access each of the plurality of databases 306 and the chassis template database 310. For instance, the user can access the display item database via the user device 308.

Typically, the user can be presented with one or more chassis templates to choose from after the customization application is initiated. In some embodiments, the chassis template customization application can present one or more chassis templates based on a few initial inquiries. For instance, the chassis template customization application may determine a general category of display items to be selected and present chassis templates that have been predetermined to match with the general category of display items. It is to be appreciated that other means of presenting an initial set of chassis templates is contemplated.

After selecting a chassis template, the chassis template customization application can analyze information included with the chassis template and determine which rules and constraints to apply when selecting display items and defining design elements. Typically, each chassis template can have a set of predefined rules that govern the chassis template. For instance, the predefined rules may include dimensions for the chassis template and a number of display spaces included with the chassis template. It is to be appreciated that a variety of rules can be predefined for each chassis template. It is to be appreciated that the process may be linear, or may be executed in a parallel or iterative fashion.

After selecting the chassis template, the chassis template customization application can present the user with a set of display items available for the chassis template. Generally, the chassis template customization application can determine which of the display items from the display item database are to be included in a first set of display items presented to the user. For instance, the chassis template may include rules governing which display items are available to be implemented with the chassis template. The user can then select a first display item for a main display space of the chassis template. Normally, the main display space can be reserved for a product that is a main focus of the marketing display. Typically, the design elements associated with the chassis template can focus on the first display item.

After the user has selected a first display item, the chassis template customization application can present a second set of display items to the user. Generally, after the first display item is selected, the customization application can check if the chassis template includes any rules regarding relationships between display items. For instance, if the chassis template includes display item relationship rules, the customization application can implement the rules when preparing the second set of display items. Generally, the customization application will check to make sure a selected display item will fit into the display space. In one embodiment, the display item database can include dimension information for each of the display items stored in the database. The user can then select a second display item from the second set of display items.

The customization application can proceed to present sets of display items until each of the display spaces of the chassis template are filled.

In some embodiments, the customization application can allow a user to select one or more display items first. After the display items have been selected, the customization application can present one or more chassis templates based on the selected display items. For instance, once the display items are selected, one or more chassis can be presented that include display spaces that can fit the display items. In another instance, the customization application can present chassis templates that have been predetermined to fit with the category of display items selected. The user can then select one of the chassis templates and proceed to define design elements on each surface of the chassis template.

After each of the display items have been selected, the customization application can present a set of content for the design elements included with the chassis template. Generally, the customization application can determine rules associated with the design elements included in the chassis template. The customization application can then fetch a set of available content from the design element database based on the design element rules of the chassis template and the previously selected display items.

The customization application can present the set of available content to the user. Typically, the content will be related to the display items previously selected. In some embodiments, the customization application can present content required to be included with the marketing display. For instance, for products claiming medical benefits, legal disclaimers may be required to be included with any advertising of the product. The customization application can include one or more options for each design element included with the chassis template.

Initially, the customization application can present content for a first surface to define design elements for. The user can then select content for each design element on the first surface. After each selection, the customization application can check rules associated with the chassis template to determine if the content selected restricts any further content available for selection. For example, if content related to legal requirements is selected first, the customization application can remove any further legal content from the set of content available for selection.

The user can proceed to select content for each design element on the first surface. As described previously, if a design element is included on another surface of the chassis template, the customization application can update the design element on all surfaces after the design element has been defined. For instance, the user may define content for a design element on a first surface. The chassis template customization application can then determine if the defined design element is included on any of the other surfaces, and if the design element is, the chassis template customization application can update the appropriate design elements on other surfaces with the selected content.

Generally, design elements included with the chassis template can be linked and/or governed by logical relationships, business rules, artistic standards, creative standards, and/or branding standards to achieve an intended objective in regard to the overall look of the chassis template. In one embodiment, design elements and display items can be linked and/or governed by logical relationships, business rules, artistic standards, creative standards, or branding standards to enforce constraints, meet design guidelines, and/or meet compliance requirements.

Typically, chassis templates can include logical coding that can specify rules governing a selection and a presentation of design elements on each surface included on the chassis template. For instance, the logical coding can be implemented to enforce consistency across various surfaces. In another instance, the logical coding can be implemented to provide logical relationships that govern the selection and the presentation of design elements on each surface included on the chassis template. For example, logical coding including, but not limited to, like if-then-else statements, inclusion statements, exclusion statements, and other such relational and logical rules.

Generally, selections and/or manipulations of design elements on any one surface of the chassis template can flow through the surfaces of the chassis template according to the specified relational and logical rules.

After the display items and design elements have been selected and defined, the customization application can generate the customized chassis template file. In some embodiments, the customized chassis template file can be automatically generated once the user has finished designing the chassis template. Generally, the customized chassis template file can include information related to (i) the chassis template, (ii) each display item selected, and (iii) content selected for each design element. For instance, the customized chassis template file can include information included in the updated metadata of the chassis template. In one embodiment, the customized chassis template file can be stored on the server 302. In another embodiment, the customized chassis template file can be stored on the user device 308. It is to be appreciated that the customized chassis template file can be stored in a plurality of different locations.

Typically, the customized chassis template file can be used to generate a bill of material for the chassis template for manufacturing the marketing display. In some embodiments, the customized chassis template file can be used to fabricate the designed chassis, procure display items for the chassis, and provide the content for the design elements when fabricating the designed chassis.

### An Embodiment of a Product Packaging Customization Process

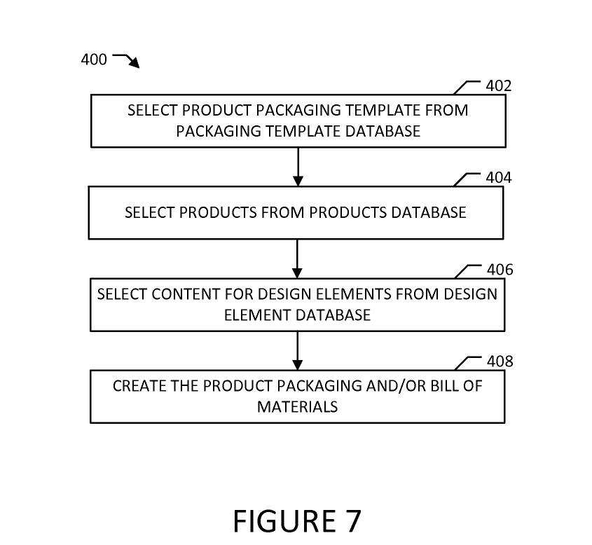

Referring to FIG. 7, a flow chart of a method or process 400 is illustrated. The process 400 can be implemented to customize a product packaging template for creating packaging for a product.

Typically, the process 400 can be implemented similarly to the marketing display customization process 100. For instance, the product packaging customization process 400 can implement substantially similar steps as the marketing display customization process 100.

In block 402, a product packaging template can be selected from a database including a plurality of product packaging templates. Each of the product packaging templates included in the database can generally include one or more design elements regulated by one or more pre-defined rules. Generally, the product packaging template database can include a plurality of parameters defining each of the product packaging templates. For instance, the parameters can include, but are not limited to, packaging material, packaging type, volume of packaging, maximum number of design elements, minimum number of design elements, product restrictions, packaging weight, packaging weight limitations, etc.

In one embodiment, each of the product packaging templates can include metadata. The metadata can be implemented to store relevant information about the product packaging template. Typically, the metadata can be updated with new data as a product packaging is being designed from the product packaging template.

After the product packaging template has been selected, the process 400 can move to block 404. In block 404, one or more products can be selected to be included in the product packaging. Typically, the product packaging template can include size parameters defining one or more display spaces to determine which products are available to be included in the product packaging. For instance, a product packaging template may include restrictions on a size of products to be displayed.

Typically, metadata of the product packaging template can be updated after products are selected to be included in the product packaging. The metadata can be updated with information related to the selected products from a product database.

In one embodiment, the steps 402 and 404 can be reversed. For instance, the products can be selected and then the product packaging can be selected based on the products selected. For example, one or more products can be selected, and then appropriate product packaging templates can be identified and presented for selection. The presented packaging templates can meet the packaging needs of the selected product(s).

In block 406, content for design elements of the product packaging template can be selected. Design elements can include, but are not limited to, images, text boxes, background color, logos, artwork, photographic elements, copy, text, layout, other characteristics that may define a look, feel, and messaging associated with packaging, and other objects appearing on the packaging. Typically, content for the design elements can be selected from a design element database including a plurality content for each type of design element.

Typically, metadata of the product packaging template can be updated after content is selected for each design element of the product packaging template. For instance, the metadata can be updated with information related to the selected content and design element.

After the design elements are defined, the process 400 can move to block 408. In block 408, a bill of materials can be created for the chassis and/or the product packaging can be created.

It is to be appreciated that rules and constraints, similar to those previously discussed, can be implemented with the product packaging templates.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

It is to be appreciated that the above disclosed description provides one example of a particular manifestation of chassis template metadata. Several schemas are possible, and the particular schema described herein is not meant to be exhaustive, nor is it intended to limit the scope of the present invention. Establishment and implementation of chassis template metadata, regardless of various alternative schemas, is encompassed within the scope of the present invention.

I claim:

1. A method of creating a marketing display, the method being performed on a processor and comprising:
selecting a chassis template from a chassis template database stored in a first nonvolatile storage, the chassis template including:
one or more display spaces;
a plurality of surfaces;
one or more design elements on each of the plurality of surfaces; and
metadata containing information related to the one or more display spaces, the plurality of surfaces, the one or more design elements, and one or more rules;
selecting one or more display items from a set of available display items, wherein each of the display items fits into at least one of the one or more display spaces;
updating the metadata of the chassis template with information related to the selected display items;
selecting content for each of the one or more design elements;
updating the metadata of the chassis template with information related to the content selected for each design element; and
generating a customized chassis template file including the updated chassis template metadata and storing the file in nonvolatile storage.

2. The method of claim 1, wherein the chassis template metadata includes dimensions for each of the one or more display spaces.

3. The method of claim 1, further comprising the step of:
fabricating the marketing display from the customized chassis template.

4. The method of claim 1, further comprising the steps of:
accessing a display item database to retrieve a plurality of display items adapted to fit into the display spaces of the chassis template, wherein the display item database is stored in a second nonvolatile storage;
selecting a first display item; and
narrowing the set of available display items based on the first display item selected.

5. The method of claim 1, further comprising the steps of:
accessing a design element database to retrieve a set of content based on the one or more display items selected, wherein the design element database is stored in a third nonvolatile storage;
selecting content for a first design element on a first surface;
determining if the first design element is included on another surface of the chassis template; and
updating the first design element on other surfaces having the first design element with the selected content.

6. The method of claim 1, the method further comprising the step of:
creating a bill of material from the customized chassis template file.

7. The method of claim 6, wherein the bill of material includes a total number of display items for each display space.

8. The method of claim 1, wherein the one or more rules govern relationships between (i) the display items, (ii) the design elements, (iii) the display items and the display spaces, and (iv) the display items and the design elements.

9. The method of claim 1, wherein content for each of the design elements is automatically selected from the available content based on the selected display items.

10. A marketing display customization system comprising:
at least one processor;
at least one computer-readable storage media having stored thereon computer-executable instructions that, when executed by the at least one processor, causes the system to perform a method, the method comprising the following:
selecting a chassis template from a chassis template database stored in a first nonvolatile storage, the chassis template including:
one or more display spaces;
a plurality of surfaces;
one or more design elements on each of the plurality of surfaces; and
metadata containing information related to the one or more display spaces, the plurality of surfaces, the one or more design elements, and one or more rules;
selecting one or more display items from a set of available display items, wherein each of the display items fits into at least one of the one or more display spaces;
updating the metadata of the chassis template with information related to the selected display items;
selecting content for each of the one or more design elements; updating the metadata of the chassis template with information related to the content selected for each design element; and
generating a customized chassis template file including the updated chassis template metadata and storing the file in nonvolatile storage.

11. The marketing display customization system of claim 10, the method further comprising the steps of:
accessing a display item database to retrieve a plurality of display items adapted to fit into the display spaces of the chassis template, wherein the display item database is stored in a second nonvolatile storage;
selecting a first display item; and
narrowing the set of available display items based on the first display item selected.

12. The marketing display customization system of claim 11, the method further comprising the steps of:
accessing a design element database to retrieve a set of content based on the one or more display items selected, wherein the design element database is stored in a second nonvolatile storage;
selecting content for a first design element on a first surface;
determining if the first design element is included on another surface of the chassis template; and
updating the first design element on other surfaces having the first design element with the selected content.

13. The marketing display customization system of claim 10, the method further comprising the step of:
creating a bill of material from the customized chassis template file.

14. The marketing display customization system of claim 13, wherein the bill of material includes a total number of display items for each display space.

15. The marketing display customization system of claim 10, wherein the one or more rules govern relationships between (i) the display items, (ii) the design elements, (iii) the display items and the display spaces, and (iv) the display items and the design elements.

16. The marketing display customization system of claim 10, wherein the chassis template metadata includes dimensions for each of the one or more display spaces.

17. The marketing display customization system of claim 16, the method further comprising the step of:
fabricating a marketing display from the customized chassis template file.

18. The marketing display customization system of claim 10, wherein the system further includes:
a display item database including a plurality of display items stored in a second nonvolatile storage, wherein the display item database includes one or more parameters for each display item;
a design element database including a plurality of content for each design element stored in a third nonvolatile storage.

19. The marketing display customization system of claim 18, wherein access to the chassis template database, the display item database, and the design element database is based on editorial rights.

20. The marketing display customization system of claim 10, wherein content for each of the design elements is automatically selected from the available content based on the selected display items.

21. A method of creating a bill of material for a marketing display performed on a processor, the method comprising:
selecting a chassis template from a chassis template database stored in nonvolatile storage, the chassis template including:
one or more display spaces;
a plurality of surfaces;
one or more design elements on each of the plurality of surfaces; and
information related to the one or more display spaces, the plurality of surfaces, the one or more design elements, and one or more rules stored in metadata of the chassis template;
selecting one or more display items from a set of available display items, wherein each of the display items fits into at least one of the one or more display spaces;
updating the metadata of the chassis template with information related to the selected display items;
selecting content for each of the one or more design elements;
updating the metadata of the chassis template with information related to the content selected for each design element;
generating a customized chassis template file including the updated chassis template metadata and storing the file in nonvolatile storage;
creating the bill of material from the customized chassis template file; and
fabricating the marketing display from the bill of material.
